(19) United States
(12) Patent Application Publication
(10) Pub. No.: US 2025/0290606 A1
(43) Pub. Date: Sep. 18, 2025

(54) REMOVABLE TANK FOR A VEHICLE, IN PARTICULAR FOR A MOTOR VEHICLE, AND VEHICLE PROVIDED WITH AT LEAST ONE SUCH TANK

(71) Applicant: ANNAJAH MOTORS, Paris (FR)

(72) Inventors: Faouzi ANNAJAH, Flavacourt (FR); Thomas DE LIGNAUD DE LUSSAC, Paris (FR); Alain DIBOINE, Gif-sur-Yvette (FR)

(21) Appl. No.: 18/858,562

(22) PCT Filed: Apr. 20, 2023
(86) PCT No.: PCT/EP2023/060222

§ 371 Date: Oct. 21, 2024

(30) Foreign Application Priority Data
Apr. 21, 2022 (FR) 2203707

(51) Int. Cl. F17C 13/08; B60K 15/063; B60K 15/067

(52) U.S. Cl. CPC F17C 13/084; B60K 15/067; B60K 2015/0638; B60K 2015/0675; F17C 2201/0104; F17C 2201/058; F17C 2205/0107; F17C 2205/0165

(57) ABSTRACT

A refillable removable tank for an electric motor vehicle, the tank having a body suitable for containing pressurized gas and a first delivery connector suitable for being associated with a second connector for a motor vehicle, the association of the first and second connectors allowing the pressurized gas to enter into and/or exit from the body of the tank. The body of the tank is elongated, has a body axis and is surrounded by a lateral protective shell that is coaxial with the body, which lateral protective shell has a handle for gripping the tank. The shell has at least two engagement elements which are aligned in a direction parallel to the axis of the body and are suitable for associating the shell with a shuttle for positioning the tank in the vehicle.

The invention relates to a tank for a vehicle, in particular for a motor vehicle, which is designed to be removable, that is, to be able to be inserted into a vehicle and removed from the vehicle.

The tank is designed to store fuel, for vehicle operation, and in particular hydrogen.

The invention thus relates, in particular, to hydrogen-powered motor vehicles.

Hydrogen-powered electric vehicles are known: they are usually equipped with a fuel cell and a hydrogen tank. Hydrogen, or more precisely dihydrogen, is used as the reducing fuel used by the fuel cell, allowing the vehicle to be propelled.

At best, such a vehicle can cover a distance of around 700 km. Another aim of the invention is to propose a vehicle, provided with a removable tank, to allow refueling by tank replacement.

To travel more than 700 km, it is therefore necessary to refill the tank: dedicated hydrogen filling service stations offer or will offer this service. However, there are very few of these stations and deployment is slow, making pressurized hydrogen refueling an uncertain proposition in many areas.

The aim of the invention is to propose a solution that allows pressurized hydrogen refueling even in areas not equipped with dedicated service stations.

A motor vehicle comprising a fuel cell and a removably mounted hydrogen tank is known from document FR 2 850 062, or document EP1 437 252. The tank is thus movable in the vehicle between a position in which it is connected to a supply line and a position in which it is disconnected from the line in order to be removed from the vehicle, for replacement thereof.

The hydrogen tank can thus be replaced when it is empty, which reduces the filling time of the vehicle.

However, as indicated in FR 2 850 062, the removable tank is heavy and it is necessary to provide means to assist the user in extracting the tank.

To this end, document FR 2 850 062 teaches a solution that makes it easier to grip the tank: the vehicle comprises telescopic arms, integral with a structural element of the vehicle, and means of removably attaching the tank to these arms (the tank is carried by the two arms attached on either side of the tank). These arms can be used to move the tank away from its connection position (at the bottom of a housing provided in the vehicle), to a position where it can be grasped more easily. In practice, the removable tank is replaced by a machine, as it is too bulky and too heavy to be grasped and moved by a person. As a result, replacing the tank described in FR 2 850 062 and EP 1 437 252 is not easy, if at all possible, to do manually. The invention proposes an improvement to this solution, offering greater safety for the user and allowing the removable tank to be replaced manually.

Document US 2010 051567 describes a system for holding and moving a propane cylinder between a first operating position and a second lower loading/unloading position relative to a support structure of a forklift. The installation comprises a base member adapted to be connected to the support structure of the forklift, a cradle for supporting the cylinder between the first and second positions, and first and second pivot arms having a first end pivotally connected to the base member and a second end pivotally connected to the cradle. In the first position, the cradle is in a horizontal orientation. In the second position, the cradle is in a vertical orientation. Angular movement of the first and second pivoting arms causes the cradle to rotate between generally horizontal and generally vertical orientations. This document does not describe a refillable removable tank for a vehicle, in particular an electric vehicle, but it does teach a possible solution for designing a removable tank for a structure.

Finally, DE 10 2007 51311 describes a fuel tank with at least one interface for a fuel cell module, the interface allowing fuel to be supplied to at least the fuel cell module and the interface allowing the fuel cell module to be releasably coupled to the fuel tank. The document also describes a fuel cell module and a method for providing at least one fuel cell module ready for operation or in operation, the fuel cell 14 has a handle positioned on top of the tank and comprises two parts which are pivotally mounted—the pivoting of the two parts allows the partial opening of a cell flap.

The invention relates to a refillable removable tank, in particular for an electric motor vehicle, said tank comprising a tank body suitable for containing a pressurized gas and a first delivery connector, attached to a first end of said tank body and suitable for being associated with a second connector for a motor vehicle, the association of the first and second connectors allowing said pressurized gas to enter into and/or exit from said body of said tank. In accordance with the invention, the removable tank is remarkable in that said tank body is elongated and has a body axis, in that said body is surrounded by a lateral protective shell of said body, said shell being coaxial with said body and comprising:
a first shell end, at least partially surrounding said first body end, said first shell end being open to provide access to said first delivery connector of said body of said tank,
a second shell end, at least partially surrounding a second end of said body and comprising a handle for gripping said tank, said shell comprising at least two gripping elements, aligned in a direction parallel to the axis of said body of said tank, the two elements being suitable for associating said shell with a positioning shuttle, to make said tank rest on said shuttle.

Thus constructed, the tank is safer and easier to position in a vehicle. In fact, the shell of the tank constitutes a protective member for the body of the tank. In addition, the aligned gripping elements make it easier to position the tank in the vehicle: in fact, it is easier to position an object along a single coupling line (alignment in the axial direction) than along two coupling lines, as is the case with the prior art solution presented briefly above (suspension of the tank by the two lateral edges thereof on rails). Having a single coupling line also makes it easy to position the tank on a forklift, for example on a shuttle as will be seen later. Finally, the end handle makes it easier for a user to remove the tank from the vehicle, since the tank has a grip element designed specifically for gripping.

Advantageously, the first shell end extends beyond said first body end and forms a protective skirt around said first body end, said skirt constituting a first engagement element, suitable for engaging a first coupling element of said shuttle. This particular shape of the first end of the shell has a dual function: it protects the first connector and it serves as a coupling/docking means for associating the shell of the tank with a shuttle, as will be seen later.

The shell may preferably comprise a housing, suitable for receiving a pin of said shuttle, said housing constituting a second gripping element. In addition, in an advantageous embodiment, the shell comprises a second handle: this allows a user to grip the removable tank with both hands, making it even easier to handle, even by a person of smaller build.

In a further advantageous embodiment, said second handle is at least partially retractable into a thickness of said shell. This ensures that the handle does not laterally obstruct the tank, so that the tank fits well into a housing of the vehicle.

The second shell end advantageously extends beyond said second body end and defines a volume extending said body. In addition, the first handle is formed in said volume extending said body, thus avoiding lateral obstruction of the tank, so as not to hinder the insertion or removal of the tank from the vehicle.

Preferably, the body has an overall mass of between approximately 1 and 30 kg: this weight makes it easy to move the tank.

Even more preferably, the body is fitted with a pressure relief valve and/or a pressure sensor and/or a temperature sensor.

Even more preferably, said shell is equipped with a display device, suitable for indicating a gauge for said body of said tank and said shell comprises at least one warning light for indicating a malfunction of said end connector.

In addition, the shell has a polygonal cross-section. This makes it possible to impose an orientation on the insertion of the tank into a compartment that is also polygonal in shape. In particular, orientation can be ensured by a foolproof device positioned on the shell and in the housing of the removable tank. This forced orientation ensures correct positioning of the tank and increases safety when attaching the tank inside the vehicle. The invention also relates to a vehicle, in particular a motor vehicle, which is remarkable in that it comprises at least one removable tank as defined above. The vehicle according to the invention comprises at least one compartment, for receiving said at least one removable tank, said at least one compartment being equipped with said at least one second connector, suitable for associating with said first connector of said removable tank, said at least one compartment comprising at least one shuttle for positioning said at least one tank, said shuttle being movably mounted on a rail, between a position for receiving said at least one tank and a position for connecting said at least one tank with said second connector, said shuttle comprising first and second coupling elements, respectively engaging with said at least two engagement elements of said at least one removable tank. In addition, said vehicle comprises a motorized device suitable for controlling the displacement of said shuttle on said rail, between said connection position and said receiving position, and vice versa.

Advantageously, the rail is oriented in an inclined position with respect to a horizontal direction when said vehicle rests on horizontal ground. The incline helps to load the tank with the aid of gravity. This also means that, if necessary, the tanks can be partially housed under the vehicle seats thus reducing the space required for the tanks in the vehicle.

Preferably, the compartment (which receives the tank) is located under a vehicle trunk and the compartment comprises a first entrance door which is independent of a second entrance door of the trunk. This meets safety standards and also allows easier access to the tanks than if they were placed in a trunk that could also hold other objects. In fact, in the event of an accident, the tank must meet two requirements:

For minor impacts (up to 15 km/h), the tank must not be touched by any part of the car and must remain removable

For major standard impacts, it must remain leakproof and present no additional risk to the integrity of the car

Advantageously, the first entrance door to the compartment is positioned at a predetermined distance of at least 40 cm from an entrance to an individual compartment, which the compartment comprises, said entrance to said at least one individual compartment being defined by one end of said rail. This makes it possible to set back the entrance to the tanks as far as possible to comply with standards, but not too far so that the tanks can be easily gripped and removed from the vehicle during replacement thereof.

In an advantageous embodiment, it is envisaged that said compartment comprises several individual compartments, each comprising a rail, a shuttle, a second connector and a motorized device for positioning and assisting the extraction of said tank.

In a preferred embodiment, the vehicle comprises a fixed tank, said at least one removable tank and said fixed tank being respectively connected to pressurized gas supply and delivery circuits, said circuits being parallel to each other, associated with a common inlet and a common outlet and being equipped with a bypass device allowing pressurized gas to pass either into one circuit or into another (always separately, never together).

In addition, the vehicle according to the invention may comprise at least one safety member, placed at least partially under said at least one rail, said at least one safety member forming a pusher in the event of a rear impact to the vehicle, to force said at least one removable tank to pivot about one end of said rail and to position itself in a substantially vertical direction when the vehicle is positioned on a horizontal support.

Advantageously, said at least one safety member comprises a first member part capable of plastic deformation, said first member part being extended by a second member part, capable of displacement under the action of a thrust of said first member part, after the plastic deformation of said first member part, in the event of a rear impact to the vehicle.

A particular advantage of the vehicle according to the invention is that it can be fitted with easily exchangeable tanks, even in non-electrified geographical areas (for example in remote villages, difficult-to-access assembly areas or in certain desert zones).

It also meets the need for clean and practical energy to replace the polluting combustion engine.

It further responds to two constraints: the complex and costly construction of service stations and the constraints associated with electric mobility which limits range, takes a long time to charge and whose batteries are a source of pollution.

The invention allows hydrogen to be transported and distributed under pressure, in the form of cylinders that can be easily delivered close to the user (either at home, or via dedicated dispensers).

This allows the user to exchange empty hydrogen cylinders for full cylinders and place the latter directly in their vehicle in a quick and simple operation.

The invention allows hydrogen to be made more accessible and not rely solely on the complex and costly hydrogen service stations that are far too few in number.

In addition, the interchangeable hydrogen cylinder refilling method is flexible and versatile:

They can either be exchanged for full ones when empty or refilled in the conventional way at a dedicated hydrogen service station, without being removed from their compartment.

Other benefits and features of the invention will become evident upon examining the detailed description of an entirely non-limiting implementation, and from the enclosed drawings wherein:

FIG. 1 is a perspective view of the rear of a vehicle according to the invention, showing an open trunk and an open rear compartment, into which several removable tanks according to the invention are inserted,

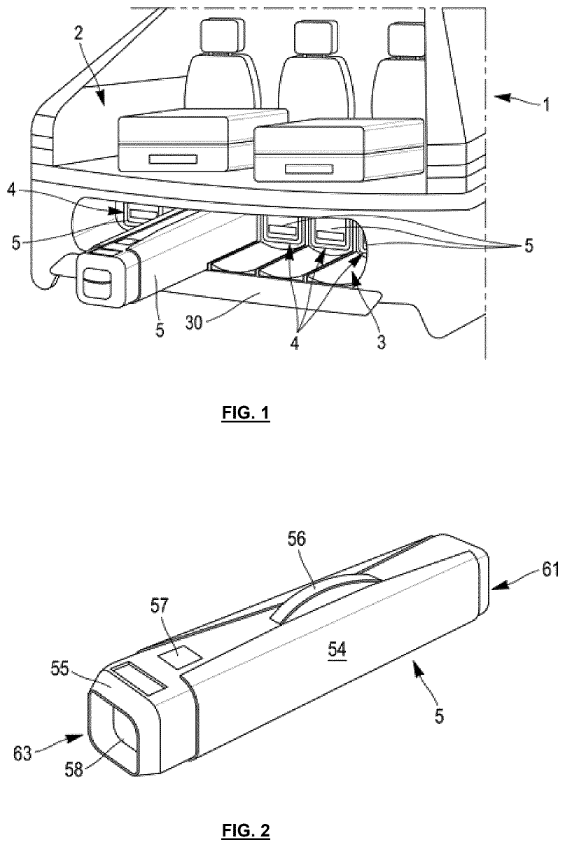

FIG. 2 is a perspective view of a removable tank according to the invention,

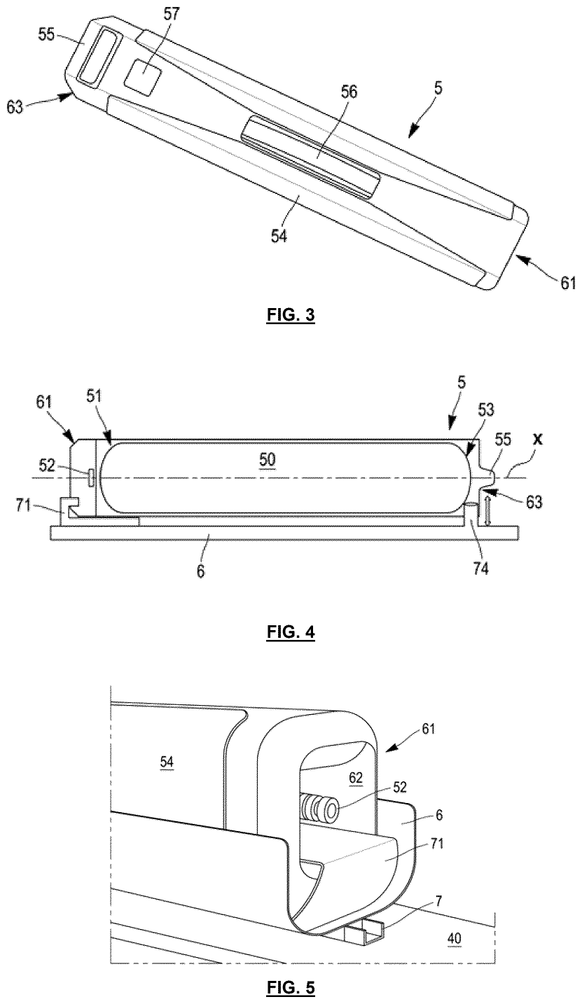

FIG. 3 is a top view of the removable tank shown in FIG. 2,

FIG. 4 is a schematic cross-section of the tank shown in FIGS. 2 and 3, mounted on a plate,

FIG. 5 is a perspective view of a first end of the tank, mounted on a plate, itself mounted on a rail,

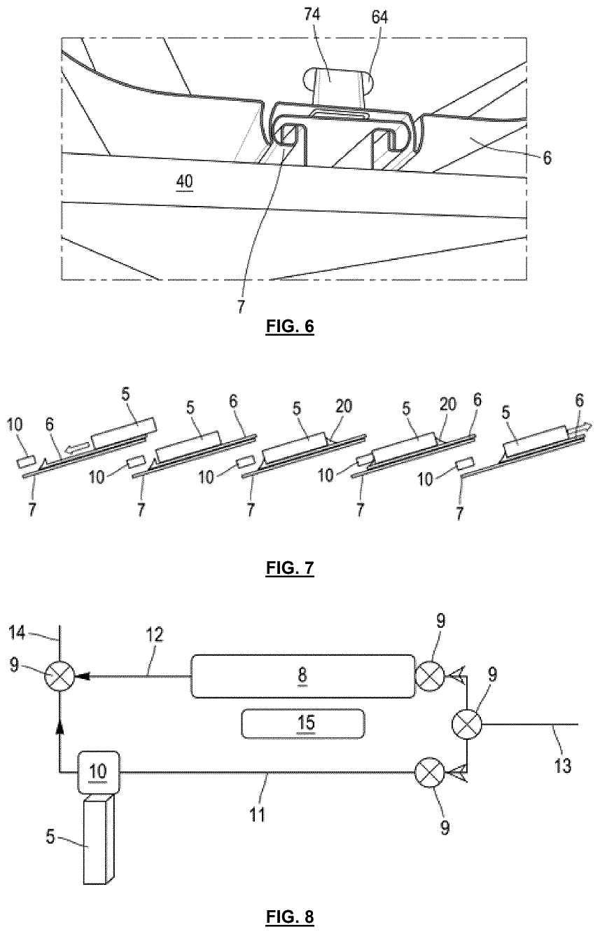

FIG. 6 is a cross-sectional, bottom and perspective view of the tank shown in FIG. 5, showing the bottom of a compartment, the rail, the plate and part of the shell of a tank according to the invention,

FIG. 7 is a schematic representation of the steps involved in positioning a removable tank in a compartment of the vehicle and removing the removable tank,

FIG. 8 is a schematic representation of the fluid relations between a fixed main tank of the vehicle according to the invention and a removable tank,

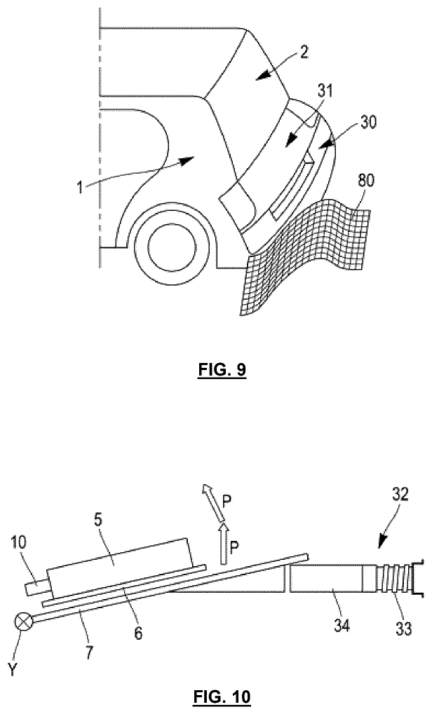

FIG. 9 is a perspective view of the rear of a vehicle according to the invention, and

FIG. 10 is a schematic representation of a safety element of a vehicle in an advantageous embodiment.

In the following description, the terms “lower”, “upper”, “left”, “right” etc., are used with reference to the drawings for greater ease of understanding. They should not be understood as limitations on the scope of the invention.

FIGS. 1 and 9 show an example of a motor vehicle according to the invention.

The vehicle according to the invention is a hydrogen-powered electric vehicle. It comprises a fuel cell and a hydrogen tank allowing the operation of the fuel cell, producing electrical energy for vehicle propulsion.

The fuel cell and the electric motor have not been shown in the figures to simplify reading, as the invention does not relate to these elements. The vehicle 1 according to the invention is shown from the rear part thereof: it comprises, in a manner which is per se conventional, a trunk 2, shown in the open position for storing luggage. The trunk lid 2 is not shown. Beneath the trunk a large compartment 3 can be seen, comprising small compartments 4 (or individual compartments 4) aligned side by side, each receiving a removable tank 5, five tanks 5 being fully positioned in their associated compartment 4 (only four tanks are visible) and a sixth tank 5 is shown partially inserted in the compartment 4 thereof.

It should be understood that the vehicle may only comprise one compartment 3, without departing from the scope of the invention.

All of the tanks 5 are pressurized hydrogen tanks. They are all removably mounted in their associated compartment 4, the compartments 4 being provided in the space beneath the trunk, access to which is independent of that of the trunk.

Indeed, the space beneath the trunk comprises its own access door 30, shown in the open position. In this position, the door 30 is oriented substantially in a horizontal plane (the vehicle itself being installed on a substantially horizontal plane) and can serve as a flat support to assist removal or positioning of the removable tank(s) in their compartment.

For reasons of compliance with safety standards, it should be noted that the entrance door 30 to the compartment is positioned at a predetermined distance from the entrance to each compartment 4: in other words, the large compartment 3 has a free space between the door 30 and the entrance to each of the compartments 4 it comprises, so that when the removable tanks are inserted into their compartment 4, they are at a distance from the door 30. It is advantageously designed so that the entrance to the individual compartments is at least 40 cm away from the door 30: in the event of rear impact at 15 km/h, no part of the structure of the car should come into contact with the removable tanks or the compartments receiving them. The distance between the door 30 and the entrance to the individual compartments ensures this safety requirement.

The bottom of each compartment 4 is fitted with a connector which is connected to a pipe for supplying pressurized gas (hydrogen) to the fuel cell of the vehicle and also for supplying hydrogen to refill the removable tanks on the vehicle.

To achieve this, each removable tank is equipped with another connector, designed to associate with the connector on the bottom of each tank, and to allow pressurized gas to pass from the tank to the supply line or from the supply line to the tank (in the particular case of filling, which will be seen later). For ease of understanding, the connector of the removable tank will be referred to as the first connector and the connector on the bottom of the compartment 4 will be referred to as the second connector.

Reference will now be made to the removable tank 5 in greater detail: FIGS. 2, 3 and 4 show an example embodiment of such a removable tank 5.

In order to be easily handled by a user, the tanks 5 are designed to weigh substantially less than 20 kg, and preferably between 8 and 15 kg (the weight of the tanks is thus well between 1 and 30 kg).

They each contain 500 g of pressurized hydrogen (at 700 bar or 700×10⁵ Pa): in fact, it is easier to handle several tanks weighing from 8 kg to 15 kg than a single tank weighing over 50 kg.

In FIG. 4, the removable tank 5 comprises a tank body 50, designed to contain and store pressurized hydrogen.

The body 50 is generally cylindrical in shape. It is thus elongated and has a tank body axis X.

It has a first body end 51 which is equipped with the first connector 52, mentioned above, ensuring the exit or entry of dihydrogen in the body 50 when it is associated with the second connector provided at the bottom of the compartments 4.

The second end 53 of the body 50 is dome-shaped.

To enhance tank safety and facilitate handling thereof, the tank comprises a lateral protective shell 54, which at least partially encloses the body of the tank, and which has a number of special features.

In this particular embodiment, the shell 54 is integral.

Firstly, the shell 54 comprises a sleeve which laterally surrounds the body 50 of the tank.

The sleeve of the shell extends from the first end 51 (corresponding to the first end 61 of the shell) up to the second end 53 of the body 50 (second end 63 of the shell).

The first function of the shell is thus to secure the body of the tank, protecting it from any possible impact.

The shell 54 is polygonal in cross-section, to impose a direction of orientation on the tank 5 in the compartment 4 thereof, which itself is also polygonal in shape.

In this example embodiment, the shell 54 has a parallelepiped shape, with a rectangular or square cross-section. The total length of the removable tank 5 is approximately 80 cm, the width is approximately 15 cm and the height is also approximately 15 cm.

The first end 61 of the shell is open, providing access to the first connector 52.

The second end 63 of the shell is partially open: it extends beyond the bottom of the body 50 of the tank and forms, around the end 53 of the body, a volume in which a handle 55 for gripping the removable tank 5 is provided: thus, the bottom of the tank (second end 53 of the shell) which faces the user who is looking at the compartments 4 receiving the removable tanks 5, can be easily gripped by the user with the aid of the handle.

The shell 54 therefore also has the function of allowing or facilitating manual gripping of the tank 5.

In an advantageous embodiment, the lateral sleeve of the shell 54 also comprises a second handle 56, visible in particular on FIGS. 2 and 3, the presence of two handles allowing the removable tank 5 to be easily and comfortably gripped with both hands.

This central handle also makes it easy to carry a tank at arm's length, like a small bag, with one hand when exchanging an empty tank for a full tank.

To allow the tank 5 to be inserted into the compartment 4 thereof without any problems, the second handle 56 is designed to be retractable into the thickness of the wall of the shell: thus, when the second handle 56 is not in use, it can be stored in a housing provided in the thickness of the shell, and does not project outside the surface of the lateral shell 54, so that it does not generate any friction or any impact against the inner wall of the compartment 4 receiving the removable tank 5.

To facilitate insertion and removal of the tank 5 in the compartment 4, the shell is designed to be positioned on a shuttle 6 movably mounted on a rail 7.

A foolproofing device on the tank and its counterpart on the housing ensure fixed and repeatable positioning on the shuttle without any risk of error.

The rail 7 is attached in the bottom 40 of a compartment 4 and extends from the compartment entrance to the bottom of the compartment.

The rail 7 is preferably a motorized rail. A special feature of the rail 7 is that it is inclined with respect to the horizontal, as will be seen later.

Thus designed, positioning the tank on the shuttle is straightforward: the tank 5 simply needs to rest on the shuttle in an appropriate manner, which is easier than suspending a tank on rails lateral to the tank, as provided for in the prior art presented above.

To ensure that the tank 5 rests appropriately on the shuttle, the shell 54 comprises at least two gripping elements, aligned in a direction parallel to the axis of the body of the tank, the two gripping elements being designed to be associated with two coupling elements on the shuttle 6.

According to the shown (but non-limiting) embodiment, one gripping element is perpendicular and the other is parallel to the axis of the body of the tank. The presence of at least two gripping elements prevents any pivoting or any movement of the tank relative to the shuttle 6: thus, when the tank 5 is associated with the shuttle, it is oriented precisely, with no possibility of movement.

The movement of the tank can thus be precisely controlled by moving the shuttle, and the tank (and in particular the first connector 52) can be brought to a precise position at the bottom of the compartment 4 (and in particular precisely opposite the second connector not shown in the figures).

The first and second connectors 52 are fast fluid connectors, which lock automatically upon insertion but require motorized unlocking for safety.

The two gripping elements of the shell 54 of the tank 5 are shown in FIGS. 5 and 6:

The first gripping element is formed by the first end 61 of the shell, which extends beyond the end 51 of the body of the tank 50, forming a protective skirt 62 around the first connector 52: the protective skirt 62 prevents impacts on the connector 52.

The protective skirt 62 also forms a first engagement element with a coupling element 71 integral with the shuttle: this element 71 is formed by an end piece of the shuttle, forming a hook, which surrounds the skirt 62 of the end 61 of the shell 54.

Thus, to position the tank 5 in the shuttle 6, the end of the tank 5 must be pushed up to the end of the shuttle in order to insert the skirt 62 of the end 61 of the shell 54 into the coupling element 71 of the shuttle 6.

The second engagement element of the shell 54 is a housing 64 formed through the wall of the shell 54, and which is capable of receiving a pin 74 that projects from the bottom of the shuttle 6 (see FIG. 6): the pin 74 can be inserted into the housing 64 of the shell when the end 61 is engaged with the coupling element 71 of the shuttle.

Note that the pin 74 is aligned with the coupling element 71, just as the housing 64 (second gripping element) of the shell of the tank 5 is aligned with the skirt 62 (second gripping element) in an axial direction, parallel to the axis of the body of the removable tank 5.

To facilitate positioning of the pin 74 in the housing 64, the pin may be retractable (for example, by being associated with an elastically deformable element, such as a spring, or by motorizing insertion of the pin 74 into the housing 64).

The body 50 of the tank is equipped with a pressure relief valve, a pressure sensor and a temperature sensor (not shown). The pressure sensor and the temperature sensor are able to communicate pressure and temperature information to a module, the module being able to deliver the information to a user by means of a display 57 or 58, for example. The module could also transmit information to a display in the vehicle or to the screen of a smartphone, by virtue of a dedicated application.

The overpressure valve ensures the release of the pressurized dihydrogen stored in the body if the pressure detected exceeds a critical pressure, beyond which the integrity of the tank may no longer be assured creating a risk for the user.

The display device 57 of the module may be provided on the sleeve of the shell 54, as shown in FIG. 2 or 3.

It may also be provided at the second end 63 of the shell (display device 58) so that, when the removable tank 5 is located in its compartment 4, the user can take note of information on pressure or temperature, on the gauge etc., without having to remove the removable tank 5.

In this specific embodiment, two screens are provided: one screen (or display device) 57 provided on the sleeve and showing the user the tank gauge and one screen 58, at the end 63 of the shell (covering the bottom of the body 50) which indicates to the user whether the tank is correctly positioned on the shuttle and possibly whether there is a problem with the first connector that could lead to a risk.

The display screen could be replaced by colored visual indicators, for example LEDs, without departing from the scope of the invention: such indicators consist of warning lights of a possible malfunction of certain elements of the tank, such as the end connector 52, for example.

Reference will now be made to FIG. 7, showing the different positions of the shuttle in the compartment 4, for the insertion of the tank.

As previously mentioned, and as can be seen in FIG. 7, the rail 7 is inclined with respect to the horizontal when the vehicle is positioned on horizontal ground. The incline of the rail 7 may, for example, preferably be between 5 and 45° with respect to the horizontal.

The shuttle 6 is movably mounted on the rail 7, between a position for receiving the tank 5 and a position for connecting the tank 5 to a device 10 equipped with the second connector, which is associated with the first connector 52.

FIG. 7 is read from left to right.

Initially, the shuttle 6 is in the receiving position: the tank 5 is brought onto the shuttle 6.

In a second step, the tank 5 is placed on the shuttle 6: this is the docking position, in which the position of the tank is locked on the shuttle 6. Symbolically, the coupling element 71 has been represented by a triangle.

In this way, the correct positioning of the tank relative to the shuttle 6 can be detected. When this detection is made, a motorized device drives the movement of the shuttle 6 from the receiving position thereof to the connection position thereof. To this end, a wedge 20 has been shown at the rear position of the tank: the wedge 20 schematically shows an interlocking device that will exert a thrust on the shuttle to bring the tank into the connection position. The wedge 20 can be realized by the pin 74 (that is, the pin 74 and the wedge 20 could be the same object), but it may also be independent of the pin 74.

The third step shows the shuttle moving towards the connection position. The incline of the rail 7 also facilitates this movement.

The fourth step shows the shuttle in the connection position and the tank connected to the device 10, which means that the first and second connectors of the body of the tank 5 and of the device 10 are perfectly assembled. The motorized device 20 further provides the necessary thrust to engage the connectors together at the end of movement of the shuttle as well as locking security.

In the fifth step, the tank 5 is removed from the compartment 4: the motorized device uses the coupling element 71 to push the shuttle 6/tank 5 assembly towards the entrance to the compartment 4.

Note that, in this example, the shuttle is moved beyond the receiving position thereof (step 1) as it at least partially moves out of the rail to move the tank closer to the user, by moving it at least partially out of the compartment 4 thereof.

It should be understood that each compartment is equipped with a rail 7, a shuttle 6 and a motorized device (symbolized at least partially by the presence of the wedge 20).

Reference will now be made to FIG. 8 to describe a further feature of the vehicle according to the invention.

In an advantageous embodiment, it is provided that the vehicle comprises not only removable tanks 5, but also a fixed tank 8, instead of the fixed tank(s) normally used in hydrogen-powered electric vehicles.

This fixed tank 8 is filled in the same way as conventional tanks, at dedicated service stations, and the tank inlet is equipped with a special refueling nozzle for hydrogen.

This fixed tank contains around 4 kg to 5 kg of dihydrogen.

The tank is also connected to the fuel cell in the conventional way.

The special feature of the invention is the combination of two fluid circuits for supplying and emptying the fixed tank 8 and the removable tanks 5: FIG. 8 shows the general architecture of the assembly produced.

All of the fluid circuits comprise bypass-type devices 9, which are activated to allow hydrogen to pass through one line or another to allow either the removable tanks 5 to be filled (or emptied) (only one has been shown in FIG. 8 but the six removable tanks are theoretically aligned along the fluid circuit 11) or the fixed tank 8 to be filled (or emptied), by controlling the passage of hydrogen through the fluid circuit 12.

A main inlet 13 is provided for both circuits 11 and 12, this inlet 13 being connected to the refueling nozzle described above. The main inlet 13 comprises a first bypass device, to allow hydrogen to pass either through the line of the fluid circuit 11 or through the line of the fluid circuit 12.

Two other bypass devices are provided at the inlet to each of the fluid circuits 11 and 12, and pressure sensors are provided between the bypass device located at the main inlet 13 and each of the bypass devices located at the inlet to the fluid circuits 11 and 12, to provide additional safety in the event of leakage.

Two other bypass devices are provided at the outlet of the fluid circuits 11 and 12.

The fluid circuits 11 and 12 are connected in parallel and join a general supply line 14 for the fuel cell (not shown).

An electronic control module 15 monitors the pressure at the inlet of each fluid circuit (by virtue of sensors which inform the control module 15) and also monitors the operation of the bypass devices so that the filling of the fixed and removable tanks complies with the following procedure:

The filling sequence starts with the fixed tank 8 (the bypass devices only allow dihydrogen to pass to the fixed tank 8 via the fluid circuit 12), until 700 bar of pressure is reached.

The removable tanks 5 are then filled, allowing only dihydrogen to pass through the fluid circuit 11: the tanks are filled in a cascading manner (the control module detecting the empty tanks to be filled).

It should be understood that the filling sequence described above is not a limitation of the invention, and that filling could take place in a different way, without departing from the scope of the invention.

To power the fuel cell, the method implemented by the control module 15 is as follows:

The removable tanks feed the fuel cell first, one after the other. However, the last of the series of six removable tanks 5 is kept full and serves as an emergency reserve (allowing the vehicle to travel between 50 and 70 km).

To enable this, the bypass devices at the outlet of the fluid circuits 11 and 12 are controlled so as to first allow the passage of hydrogen from the first five removable tanks and prevent the passage of hydrogen from the circuit 12).

Then, when the first five removable tanks 5 are emptied, the control module 15 authorizes the passage of hydrogen from the circuit 12 (stored in the tank 8) to the fuel cell.

When the vehicle user wishes to refuel, he can thus either replace the empty removable tanks 5 with other full removable tanks 5, or fill the fixed tank 8 and the removable tanks 5 using the pump, depending on the time available and the technical means offered by the station (full removable tanks in stock, available pump, etc.).

The removable tanks will also be available in low-cost automatic dispensers that are easier to install than conventional hydrogen stations. The location, availability and payment of these removable automatic dispensers can be managed via a dedicated digital application on a smartphone or other suitable device.

It should be noted that, by virtue of the simplicity of the removable tank exchange system, one of the advantages of the invention is that removable tanks can be delivered directly to the user (home, workplace or other) thus making it considerably easier to supply hydrogen to the user anywhere and at any time. A disruptive way of refueling a vehicle compared with the usual methods of refilling with gasoline or other gases.

Reference will now be made to FIGS. 9 and 10 to present a further special feature of the vehicle according to the invention.

It is known that hydrogen-powered electric vehicles must meet safety standards designed to prevent any risk of the vehicle exploding in the event of a rear-end vehicle collision in particular.

The vehicle according to the invention provides means for ensuring movement of the removable tanks in the event of a rear-end vehicle collision, in order to convert part of the impact energy received into movement and limit the effect of the impact on the removable tanks (to preserve them as much as possible).

FIG. 9 shows the rear of a vehicle according to the invention, with its trunk 2, its large compartment 3—located under the trunk—with its access door 30 (the large compartment 3 comprising the individual compartments 4 each receiving the removable tanks 5).

A strip 31 formed by a part of the bodywork is visible between the access door 30 of the large compartment 3 and the trunk lid 2.

The strip 31 is a strip of bodywork that forms a fuse, capable of absorbing part of the energy generated during an impact by destroying itself, for example during the impact.

An impact wall is represented schematically by reference 80.

In accordance with an advantageous embodiment, the vehicle also comprises a safety member internal to the vehicle, which is designed to force the removable tank(s) 5 to pivot about one end of said rail 7 and position itself in a direction substantially:

FIG. 10 schematically shows such a safety member 32, which is located at least partially under the rail(s) 7.

The safety member 32 is designed to form a pusher in the event of a rear impact to the vehicle, which forces the removable tank 5 (or removable tanks 5) to pivot.

To achieve this, the safety member 32 comprises a first member part 33 capable of plastic deformation (the first member part deforms like an accordion, and stores energy).

The first member part 33 is extended by a second member part 34 which is positioned under the rail and which is designed to move under the action of a thrust of said first member part 33.

To achieve this, the second member part is made of a more resistant material, which forces the movement of this second part (under the action of the movement of the first member part 33 itself after the plastic deformation thereof) before its eventual deformation and eventual destruction, in order to push on the rail and force the pivot P thereof around a pivot axis Y, resulting in the positioning of the removable tank 5 positioned above the rail in a vertical position or at least in an inclined position approaching a vertical position.

The safety member 32, combined with the strip 31, allows the removable tanks 5 to be optimally preserved and allows them to be removed from the vehicle.

It is clear from the above description how the invention proposes a new hydrogen-powered electric vehicle that offers greater performance by virtue of the presence of several removable tanks, how such a vehicle offers solutions that save the user time when refueling with hydrogen, and how it can be refueled anywhere thanks to simple dispensers or by having removable tanks delivered to the user's location, proposing a simple and secure solution for replacing removable tanks and offering optimum safety features.

It should be understood that the invention may have alternative embodiments which have not been presented above and that it extends to the implementation of equivalent means.

1. A refillable removable tank for a vehicle, said tank comprising a body suitable for containing a pressurized gas and a first delivery connector, attached to a first end of said tank body and suitable for being associated with a second connector for a motor vehicle, the association of the first and second connectors allowing said pressurized gas to enter into and/or exit from said body of said tank, said removable tank comprising:
said tank body is elongated and has a body axis;
said body is surrounded by a lateral protective shell of said body, said lateral shell being coaxial with said body and comprising:
a first shell end, at least partially surrounding said first body end, said first shell end being open to provide access to said first delivery connector of said body of said tank;
a second shell end, at least partially surrounding a second end of said body and comprising a handle for gripping said tank; and
said shell comprising at least two gripping elements, aligned in a direction parallel to the axis of said body of said tank, the two gripping elements being suitable for associating said shell with a positioning shuttle, to make said removable tank rest on said shuttle.

2. The refillable removable tank according to claim 1, characterized in that said first shell end extends beyond said first body end and forms a protective skirt around said first body end, said skirt constituting a first engagement element, suitable for engaging with a first coupling element of said shuttle.

3. The removable tank according to claim 1, characterized in that said shell comprises a housing suitable for receiving a pin of said shuttle, said housing constituting a second engagement element.

4. The removable tank according to claim 1, characterized in that said shell comprises a second handle.

5. The tank according to claim 4, characterized in that said second handle is at least partially retractable into a thickness of said shell.

6. The removable tank according to claim 1, characterized in that said second shell end extends beyond said second body end and defines a volume extending said body and in that said first handle is formed in said volume extending said body.

7. The removable tank according to claim 1, characterized in that said body has an overall mass of between approximately 1 and 30 kg.

8. The removable tank according to claim 1, characterized in that said body is equipped with a pressure relief valve and/or a pressure sensor and/or a temperature sensor.

9. The removable tank according to claim 1, characterized in that said shell is equipped with a display device, suitable for indicating a gauge of said body and in that said shell comprises at least one warning light for indicating a malfunction of said first connector.

10. The removable tank according to claim 1, characterized in that said shell has a polygonal cross-section.

11. A vehicle, in particular a motor vehicle, characterized in that it comprises at least one removable tank according to claim 1, further comprising at least one compartment for receiving said at least one removable tank,
said at least one compartment being equipped with said at least one second connector, suitable for associating with said first connector of said removable tank,
said at least one compartment comprising at least one shuttle for positioning said at least one tank, said shuttle being movably mounted on a rail between a position for receiving said at least one tank and a position for connecting said at least one tank to said second connector, said shuttle comprising first and second coupling elements, respectively engaging with said at least two engagement elements of said at least one removable tank,
and said vehicle comprises a motorized device capable of controlling the movement of said shuttle on said rail, between said connection position and said receiving position, and vice versa.

12. The vehicle according to claim 11, characterized in that said rail is oriented in an inclined position with respect to a horizontal direction when said vehicle rests on horizontal ground.

13. The vehicle according to claim 11, characterized in that said at least one compartment is located under a trunk of said vehicle and in that said compartment comprises a first entrance door which is independent of a second entrance door to the trunk.

14. The vehicle according to claim 13, characterized in that the first entrance door to the compartment is located at a predetermined distance of at least 40 cm from an entrance to an individual compartment for receiving said removable tank, said entrance to said at least one individual compartment being defined by one end of said rail, said compartment comprising said individual compartment.

15. The vehicle according to claim 11, characterized in that said compartment comprises a plurality of individual compartments, each of the individual compartments comprising a rail, a shuttle, a second connector and a motorized device for positioning the removable tank, and assisting in the extraction of said removable tank.

16. The vehicle according to claim 11, characterized in that it comprises a fixed tank, said at least one removable tank and said fixed tank being connected respectively to circuits for supplying and delivering pressurized gas, said circuits being parallel to one another, associated with a common inlet and a common outlet and being equipped with a bypass device allowing pressurized gas to pass either into one circuit or into another.

17. The vehicle according to claim 11, characterized in that it comprises at least one safety member, placed at least partially under said at least one rail, said at least one safety member forming a pusher in the event of a rear impact to the vehicle, to force said at least one removable tank to pivot about an end axis of said rail and to position itself in a substantially vertical direction when the vehicle is positioned on a horizontal support.

18. The vehicle according to claim 17, characterized in that said at least one safety member comprises a first member part capable of plastic deformation, said first member part being extended by a second member part, capable of moving under the action of a thrust of said first member part, after the plastic deformation of said first member part, in the event of a rear impact to the vehicle.
